(19) United States
(12) Patent Application Publication
(10) Pub. No.: US 2015/0332281 A1
(43) Pub. Date: Nov. 19, 2015

(54) METHODS AND APPARATUS FOR COMPUTER CONDONIMIUM

(71) Applicant: SOCIOCYBERNETICS, Sewanee, TN (US)

(72) Inventors: Henry Hamman, Sewanee, TN (US); Joseph P. Kincart, Jacksonville, FL (US)

(21) Appl. No.: 14/691,539

(22) Filed: Apr. 20, 2015

Related U.S. Application Data
(60) Provisional application No. 61/981,215, filed on Apr. 18, 2014.

(51) Int. Cl. G06Q 30/00; H04L 29/08

(52) U.S. Cl. CPC G06Q 30/018; H04L 67/10

(57) ABSTRACT

A computer condo device including a digitally controllable apparatus, such as a digital storage with an ownership interest allocated to a legal entity and a support structure capable of providing digital access to the digital storage for data owned or controlled by a legal person.

### CROSS REFERENCE TO RELATED APPLICATIONS

This application claims the benefit of the U.S. Provisional Application Ser. No. 61/981,215 filed on Apr. 18, 2014 and entitled “Methods and Apparatus for Computer Apparatus” the contents of which are relied upon and incorporated herein.

### FIELD OF THE INVENTION

This invention relates to automated methods and apparatus for owning a private Digitally Controllable Apparatus stored within a provider facility that is made accessible via a digital communication network. More specifically, the present invention relates to methods and apparatus for providing an ownership interest in a condominium of Digitally Controllable Apparatus and access to the Digitally Controllable Apparatus via digital common area apparatus.

### BACKGROUND

The law provides for several types of ownership interests in multiple unit real estate. Two known and recognized ownership interests by independent owners include condominiums and cooperatives which are associated with multiple-unit dwellings. Both condominiums and cooperatives may have independent owners or lessees of the individual units that are included in a multiple-unit dwelling. The owners and/or lessees generally share various costs and responsibilities of areas for which they have rights of common use.

A condominium is a multiple-unit dwelling in which there is separate and distinct ownership of individual units and joint ownership of common areas. Common areas often provide access to the individual units and may also enhance owner's use of the individual units. For example, in an apartment house, the individual owners would each own their own apartments while all the owners of the separate apartments would together own the parts of the building common to all of them, such as the entrances, laundry rooms, elevators, and hallways. The building is managed by the condominium association, either directly or through a professional manager. The owners of the individual units are jointly responsible for the costs of maintaining the building and common areas, but they are individually responsible for the maintenance expenses of their particular units.

A cooperative apartment house is usually owned and managed by a corporation, and the shareholders are tenants who lease their apartments from the corporation. The relative size of the apartment that a shareholder-tenant leases determines the proportion of the corporation's stock that that shareholder owns. Each shareholder-tenant pays a monthly assessment, based upon his or her proportionate share of the stock, to cover the principal and interest on the building mortgage, taxes, and maintenance costs.

A “timeshare” is another form of shared property ownership rights. In a timeshare, ownership rights vest in multiple owners to use property under specified conditions, such as specified time periods.

Timeshare ownership of vacation or recreation condominium property is a popular choice for persons in states such as Hawaii, Florida, Arizona, Colorado, and Mexico, as well as in certain other popular vacation spots in the United States. Generally, a person signs a contract to purchase a “timeshare,” and agrees to pay the owner of the property a sum of money for the exclusive right to use or occupy the property for a specified time during the year. One or two weeks is the typical period that may be purchased. Under common usage, a timeshare agreement is made for improved property, such as a vacation home or a particular unit in a condominium complex.

The form of a timeshare agreement varies. Usually, the person has the right of exclusive use of the unit during the same time each year or other specified period. Each timeshare unit is considered an estate or interest in real property, separate and distinct from all other timeshare estates in the same unit or any other unit. Therefore, estates may be separately conveyed and encumbered.

Generally, laws that apply to protection of a person's ownership of property apply to condominiums, cooperatives and time shares. Accordingly, trespass and taking of property included in a condominium, cooperative and time share is protected.

What is needed is an automated apparatus for providing protection against virtual trespass and/or taking of property comprising information.

### SUMMARY

Accordingly, the present invention provides apparatus and methods for providing an ownership right in a Digitally Controllable Apparatus accessible via a digital communications network and digital communication common area apparatus. A Digitally Controllable Apparatus (sometimes referred to herein as a “DCA”) may include, for example, one or more of: a data storage, a machine, a device and a sensor. Access to, and control of the DCA is made available via Common Area Apparatus, such as a network server and modem in logical communication with a digital communication network, such as the Internet.

In some embodiments, an ownership interest will include separate and distinct ownership in an individual unit. Separate and distinct ownership may include one or both of: a distinct physical unit and a virtual unit defined by software. Some preferred embodiments include a Digitally Controllable Apparatus ownership interest with rights in a storage medium for storing digital property.

A Digitally Controllable Apparatus may be associated with joint ownership rights in a “common area”. Similar to real property condominiums, Digital Common Areas may provide access to the individual units of Digitally Controllable Apparatus and may also enhance an owner's use of the individual units. Accordingly, Digital Common Areas may include shared access to processors, communication devices, data busses, data backbones, cache memory, data backup devices, data input devices, operating systems, executable software, power sources, facilities and other apparatus, devices, automation and machines.

In some embodiments, an Owner may own a physical storage device such as a magnetic hard drive, a solid state memory device, an optical disk storage, or other Digitally Controllable Apparatus and send a request via a communications network to a Digital Storage Common Area Management to have the Digitally Controllable Apparatus made available. Based upon the request, the Digital Storage Common Area Management will have automation or a person physically place the Digitally Controllable Apparatus in logical communication with the communication network such that the Owner may communicate with the Digitally Controllable Apparatus. In this manner, the Digitally Controllable Apparatus is further protected from unauthorized access during the time that the Digitally Controllable Apparatus is not in logical communication with the Communications Network.

Some embodiments may also include a communication being sent to the Owner indicating each time that access to the Digitally Controllable Apparatus was requested and/or access was made.

In a related manner, a Digitally Controllable Apparatus may be periodically removed and physically transported to an Owner and a replacement Digitally Controllable Apparatus may be owned by the Owner and made available via the Digital Common Area Management. For example, with the increased miniaturization and decrease in cost of magnetic hard drives, Solid State Storage, and other storage devices, the cost of periodic replacement is decreasing. A “thumb drive” may be owned by an Owner and placed in an array of thumb drives for a period of time and then removed and shipped to the Owner as a backup, while a replacement thumb drive is placed online and made available for storage by the owner. In addition, in some embodiments, the thumb drive may be physically removed from communication with the communication network until a request is received from the Owner and then placed in communication with the Communications Network. The Owner remains the owner of the thumb drive and enjoys all of the rights of ownership under the jurisdiction in which the thumb drive is located and also enjoys increased protection from unauthorized access. Other type of digital storage, such as a hard drive or an optical storage, may also be treated in manner as described above.

While the Digitally Controllable Apparatus is connected, to a communication network, such as the World Wide Web (“WWW”), one or more users may access the Digitally Controllable Apparatus. Rights of access may be managed on a user by user basis, by groups of users, or as a whole. Accordingly, third parties may be granted access and access rights and privileges managed by an Owner or an owner's agent. Access rights and privileges may be functionally implemented according to the Owner's instruction by a Digital Common Area Management.

In another aspect, in some embodiments, a Digital Storage Common Area Management or an owner may perform back up activities to a computing device and storage mechanism maintained by the Owner. In such embodiments, a “snapshot” of a Digitally Controllable Apparatus may be generated by the Owner and kept local to the Owner while the online storage mechanism is maintained by a service provider.

In still another aspect, a Service Provider may provide a list of services and allow an Owner to select which services the Owner wishes the Service Provider to perform. Compensation may be made to the Service Provider based upon which services are performed.

In a similar respect, a Service Provider may offer to maintain Digitally Controllable Apparatus's owned by an Owner in multiple locations and provide duplication service to copy data stored on one Digitally Controllable Apparatus to other owned Digitally Controllable Apparatus. Data stored in multiple locations may be useful in the event of an interruption in one location, such as because of an act of nature or an act of war. A Service Provider may charge fees according to a number of locations in which Digitally Controllable Apparatus are maintained. Other service models may include charging according to a number of services utilized and/or a number of services available.

As with real property, Digitally Controllable Apparatus may be bought and sold and may be traded according to a make, model and serial number. An exchange may list details for example, including, for example, Digitally Controllable Apparatus type and size, location, and Service Provider and a value or net worth may be based upon such factors.

In another aspect, access to a Digitally Controllable Apparatus may be made available from any location in the world connected to the Internet. Access to the internet becomes more universal throughout the world as technology becomes more and more widespread. Wireless and cellular connection to the internet also increases the locations from which Digitally Controllable Apparatus may be accessed. Digital storage of Digitally Controllable Apparatus also allows for redundancy and backups such that even in the event of a natural disaster or act of war, so long as the Internet is operational, the Digitally Controllable Apparatus should be accessible.

In still another aspect, an Digitally Controllable Apparatus may include a tracking device, such as a hash mark, a radio frequency identifier (RFID), barcode or other tracking apparatus that allows a specific location of an Digitally Controllable Apparatus to be tracked and logged so that an owner may be aware of its location at all times and also have a record of times that the Digitally Controllable Apparatus was placed in communication with a processor or other access device.

### DESCRIPTION OF THE DRAWINGS

FIG. 1 illustrates block components that may be utilized to implement some embodiments of a digitally controllable apparatus condominium.

FIG. 2 illustrates a detailed diagram with exemplary entities that may be involved in some implementations of the present invention.

FIG. 3 illustrates exemplary components that may be included as digitally controllable apparatus in some embodiments of the present invention.

FIG. 4 illustrates aspects of controller hardware useful for implementing the present invention as a block diagram.

FIG. 5 illustrates an exemplary processing and interface system.

FIG. 6 illustrates a block diagram of an exemplary embodiment of a mobile device.

FIG. 7 illustrates a flow diagram of method steps that may be implemented in some embodiments of the present invention.

### DETAILED DESCRIPTION

This invention relates to automated methods and apparatus for owning a private Digitally Controllable Apparatus stored within a provider facility that is made accessible via a digital communication network. More specifically, the present invention relates to methods and apparatus for providing an ownership interest in a condominium of Digitally Controllable Apparatus and access to the Digitally Controllable Apparatus via digital common area apparatus.

In some embodiments, an ownership interest will include separate and distinct ownership in an individual unit. Separate and distinct ownership may include one or both of: a distinct physical unit and a virtual unit defined by software. Some preferred embodiments include a Digitally Controllable Apparatus ownership interest with rights in a storage medium for storing digital property.

A Digitally Controllable Apparatus may be associated with joint ownership rights in a “common area”. Similar to real property condominiums, Digital Common Areas may provide access to the individual units of Digitally Controllable Apparatus and may also enhance an owner's use of the individual units. Accordingly, Digital Common Areas may include shared access to processors, communication devices, data busses, data backbones, cache memory, data backup devices, data input devices, operating systems, executable software, power sources, facilities and other apparatus, devices, automation and machines.

In some embodiments, an Owner may own a physical storage device such as a magnetic hard drive, a solid state memory device, an optical disk storage, or other Digitally Controllable Apparatus and send a request via a communications network to a Digital Storage Common Area Management to have the Digitally Controllable Apparatus made available. Based upon the request, the Digital Storage Common Area Management will have automation or a person physically place the Digitally Controllable Apparatus in logical communication with the communication network such that the Owner may communicate with the Digitally Controllable Apparatus. In this manner, the Digitally Controllable Apparatus is further protected from unauthorized access during the time that the Digitally Controllable Apparatus is not in logical communication with the Communications Network.

Some embodiments may also include a communication being sent to the Owner indicating each time that access to the Digitally Controllable Apparatus was requested and/or access was made.

In a related manner, a Digitally Controllable Apparatus may be periodically removed and physically transported to an Owner and a replacement Digitally Controllable Apparatus may be owned by the Owner and made available via the Digital Common Area Management. For example, with the increased miniaturization and decrease in cost of magnetic hard drives, Solid State Storage, and other storage devices, the cost of periodic replacement is decreasing. A “thumb drive” may be owned by an Owner and placed in an array of thumb drives for a period of time and then removed and shipped to the Owner as a backup, while a replacement thumb drive is placed online and made available for storage by the owner. In addition, in some embodiments, the thumb drive may be physically removed from communication with the communication network until a request is received from the Owner and then placed in communication with the Communications Network. The Owner remains the owner of the thumb drive and enjoys all of the rights of ownership under the jurisdiction in which the thumb drive is located and also enjoys increased protection from unauthorized access. Other type of digital storage, such as a hard drive or an optical storage, may also be treated in manner as described above.

While the Digitally Controllable Apparatus is connected, to a communication network, such as the World Wide Web (“WWW”), one or more users may access the Digitally Controllable Apparatus. Rights of access may be managed on a user by user basis, by groups of users, or as a whole. Accordingly, third parties may be granted access and access rights and privileges managed by an Owner or an owner's agent. Access rights and privileges may be functionally implemented according to the Owner's instruction by a Digital Common Area Management.

In another aspect, in some embodiments, a Digital Storage Common Area Management or an owner may perform back up activities to a computing device and storage mechanism maintained by the Owner. In such embodiments, a “snapshot” of a Digitally Controllable Apparatus may be generated by the Owner and kept local to the Owner while the online storage mechanism is maintained by a service provider.

In still another aspect, a Service Provider may provide a list of services and allow an Owner to select which services the Owner wishes the Service Provider to perform. Compensation may be made to the Service Provider based upon which services are performed.

In a similar respect, a Service Provider may offer to maintain Digitally Controllable Apparatus's owned by an Owner in multiple locations and provide duplication service to copy data stored on one Digitally Controllable Apparatus to other owned Digitally Controllable Apparatus. Data stored in multiple locations may be useful in the event of an interruption in one location, such as because of an act of nature or an act of war. A Service Provider may charge fees according to a number of locations in which Digitally Controllable Apparatus are maintained. Other service models may include charging according to a number of services utilized and/or a number of services available.

As with real property, Digitally Controllable Apparatus may be bought and sold and may be traded according to a make, model and serial number. An exchange may list details for example, including, for example, Digitally Controllable Apparatus type and size, location, and Service Provider and a value or net worth may be based upon such factors.

In another aspect, access to a Digitally Controllable Apparatus may be made available from any location in the world connected to the Internet. Access to the internet becomes more universal throughout the world as technology becomes more and more widespread. Wireless and cellular connection to the internet also increases the locations from which Digitally Controllable Apparatus may be accessed. Digital storage of Digitally Controllable Apparatus also allows for redundancy and backups such that even in the event of a natural disaster or act of war, so long as the Internet is operational, the Digitally Controllable Apparatus should be accessible.

In still another aspect, an Digitally Controllable Apparatus may include a tracking device, such as a hash mark, a radio frequency identifier (RFID), barcode or other tracking apparatus that allows a specific location of an Digitally Controllable Apparatus to be tracked and logged so that an owner may be aware of its location at all times and also have a record of times that the Digitally Controllable Apparatus was placed in communication with a processor or other access device.

“Digital Common Area Apparatus” as used herein shall mean apparatus which is made available for use by more than one person via digital communication. The common area apparatus are those devices within a provider facility, providing access to one or more machines controllable via digital logic, which are available for common use by all tenants, (or) groups of tenants and their invitees.” The Common Area Apparatus includes access to apparatus inside the Provider Facility, such as a storage provider facility, that are owned by all tenants or by an overall management structure which charges each tenant for maintenance and upkeep.

“Mobile device” as used herein is a wireless mobile communications network access device for accessing a server in logical communication with a communications network. The mobile device may include one or more of a cellular, mobile or CDMA/GSM device, a wireless tablet phones, personal digital assistants (PDAs),

“Mobile network” as used herein includes 2G, 3G, 4G internet systems and wireless fidelity (Wi-Fi), Wireless Local Area Network (WLAN), Worldwide Interoperability for Microwave Access (Wi-MAX), Global Mobile System (GSM) cellular network, spread spectrum and CDMA systems, Time division multiple access (TDMA), and Orthogonal frequency-division multiplexing (OFDM). The mobile device is capable of communicating over one or more mobile network.

“Network Access Device: shall mean an electronic device with a human interactive interface capable of communicating with a Network Server via a digital communication.

“User interface” or “Web interface” is a set of graphical controls through which a user communicates with one or both of a Digitally Controllable Apparatus and a Common Area Apparatus. The user interface includes graphical controls such as button, toolbars, windows, icons, and pop-up menus, which the user can select using a mouse or keyboard to initiate required functions on the Yearbooker interface.

“Wireless” includes a communication protocol and hardware capable of digital communication without hardwire connections. Examples of Wireless include: Wireless Application Protocol (“WAP”) mobile or fixed devices, Bluetooth, 802.11b, or other types of wireless mobile devices.

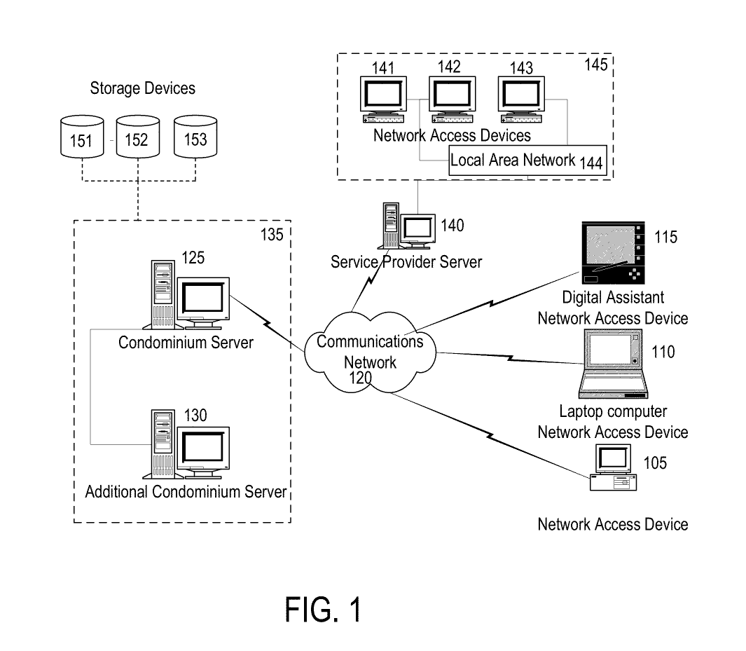

Referring now to FIG. 1, a processing and interface system 100 for a computer storage condominium is illustrated. The system 100 may comprise a service provider server 140; a Common Area 135, comprising condominium servers 125, 130; detachable Digitally Controllable Apparatus 151, 152, 153; and network access devices 105-115.

The network access devices 105-115 may allow an Owner to interface with the system 100.

In some embodiments, the system 100 may be linked through a variety of networks. For example, a branch of the system, such as the Digital Storage Common Area Management server 140, may have a separate communication system 145, wherein multiple network access devices 141-143 may communicate through a local area network (LAN) 144 connection. The local network access devices 141-143 may include a tablet, a personal computer, a computer, a mobile phone, a laptop, a mainframe, or other digital processing device

The Digital Storage Common Area Management server 140 may connect to a separate communications network 120, such as the Internet.

Similarly, network access devices 105-115 may connect to one or both the Condominium servers 135 and the Digital Storage Common Area Management server 140 through a communications network 120. The network access devices 105-115 may be operated by multiple parties. For example, a digital assistant network access device 115 may comprise a Product-matching station located at a vendor's brick and mortar location. A laptop computer network access device 110 may be a personal device owned by an individual Purchaser. Other types of network access devices 105 may be interfacing systems built into the manufacturing process, for example.

Accordingly, the servers 125, 130, 140 and network access devices 105-115 are separate entities for illustrative purposes only. For example, the Digital Storage Common Area Management server 140 may be operated by the Digital Common Area Management, and the condominium servers 125, 130 may be integrated into the Digital Storage Common Area Management server communication system 145. The Digital Storage Common Area Management may also provide a digital assistant network access device 115 to Owners. Alternatively, the Digital Storage Common Area Management may only provide the access device 115 to Owners. In some such aspects, the servers 125, 130, 140 may be operated by a third party or multiple third parties, such as, for example, the manufacturers of the Products carried by the vendor.

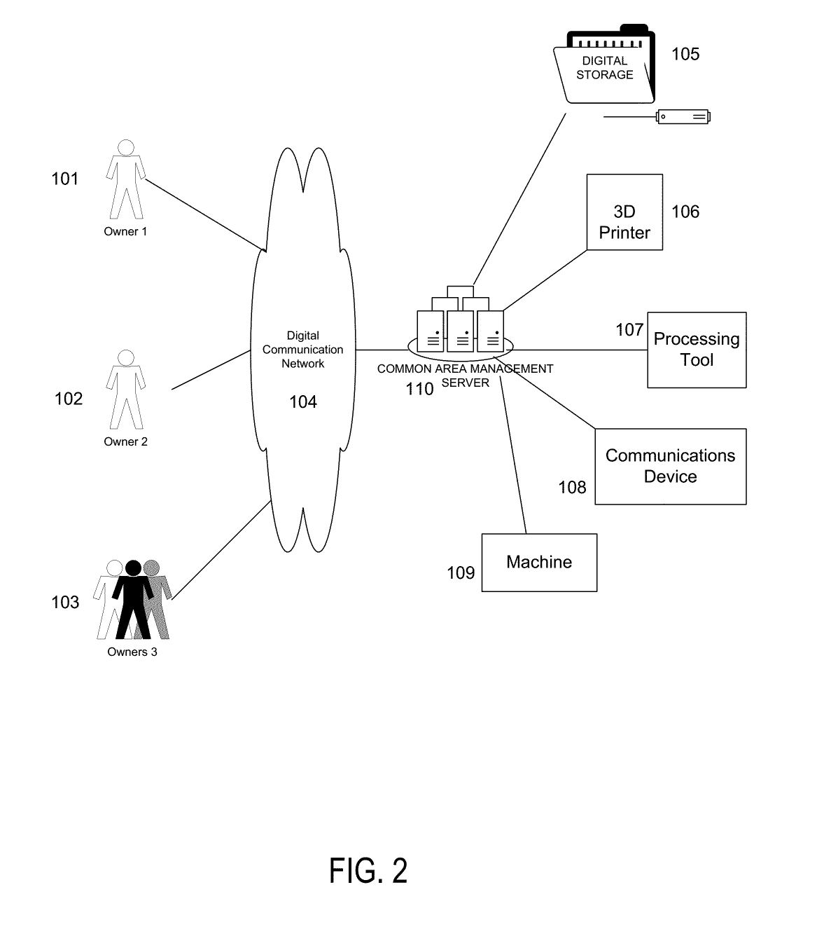

Referring now to FIG. 2, a block diagram illustrates components of exemplary embodiments of the present invention. Owners 101-103 may be any person in a legal sense, a therefore include individuals, companies and corporate entities. Owners may access a digital communications network utilized network access devices and/or mobile devices, more fully described herein. One or more Common Area Management Servers 110 are also in digital communication with the Digital Communication Network 104.

The one or more Common Area Management Servers 110 may also be in logical digital communication with each other and one or more User owned Digitally Controllable Apparatus 105-109.

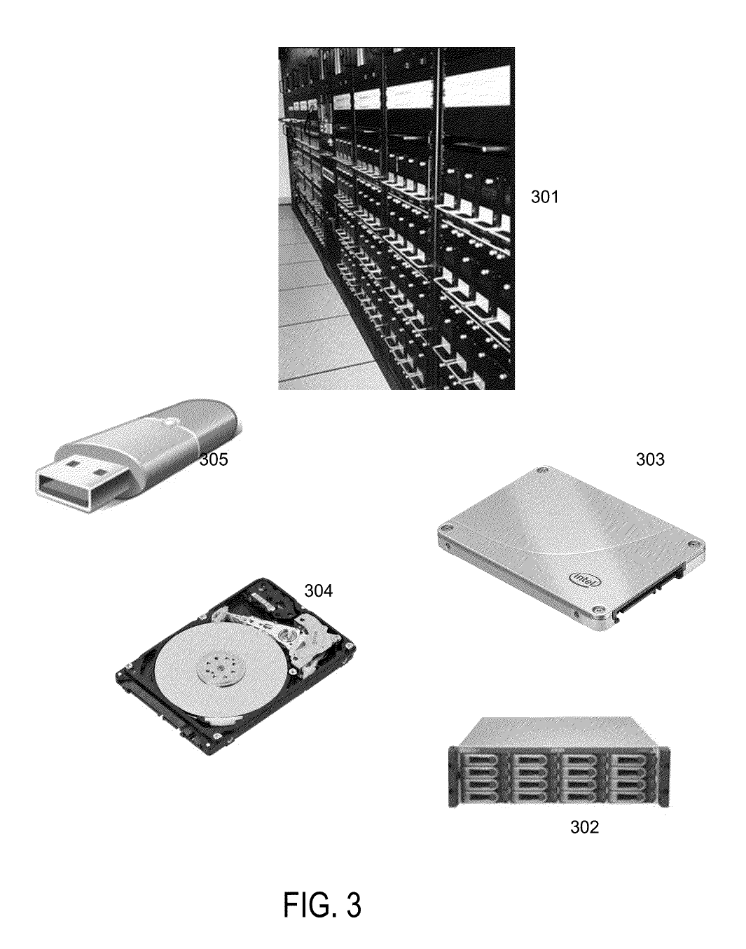

Referring now to FIG. 3, various storage devices are illustrated which may Digitally Controllable Apparatus according to the present invention and support infrastructure are illustrated. A rack, including an array of computer condo devices may be slid into and out of a support infrastructure including power, data bus, communications devices, modems, routers and other equipment conducive to placing a personalized and personally owned digital storage device in logical communication with a user network access device or other automated device.

Digitally Controllable Apparatus 303-305 may include, by way of non-limiting example, an SSID or other solid state device 303, a Winchester drive or other computer hard drive 304, and a memory stick 305. Storage devices 303-305 may also be inserted into a removable rack 302 which may be supported by a rack 301 for storage devices.

Embodiments include a computer server to implement the above methods via executable software stored on the server. If desired, the executable software may be executed on demand via the network access device over a communications network. A network access device will typically be an electronic device such as a computer or a wireless computing device, which may include one or more of wireless, mobile and cellular linked tablets, smart phones and flat panel digital or projection display devices. Devices may conform to the transmission control protocol/internet protocol, cellular protocol or other communication protocol.

In various embodiments, features may include one or more of: automation for inserting and removing a Digitally Controllable Apparatus into a data infrastructure; Back up and Shipping of Digitally Controllable Apparatus to an owner or an owner designee. Physically remove Digitally Controllable Apparatus from connecting back bone or buss to prevent access and reconnecting Digitally Controllable Apparatus upon request to allow access to Digitally Controllable Apparatus.

In some embodiments, a Digitally Controllable Apparatus may be accessed based upon a unique address, such as, for example a TCP/IP address or another logical address, i.e. a port and device identification.

Implementations ma also include an electronic message being generated and sent to an Owner or an Owner designee to notify the Owner of any request to access a Digitally Controllable Apparatus and require approval from the Owner or designee before access is granted.

In some embodiments, a direct access is established between an owner network access device and a Digitally Controllable Apparatus. Access may be granted, for example via a display a registry of resources available on the plurality of network access devices; associate a personal network address with each available resource, wherein the personal network address comprises an internet protocol address portion and a port number portion; and establish a direct communications link between one network access device hosting an available resource and another network access device utilizing the personal network address.

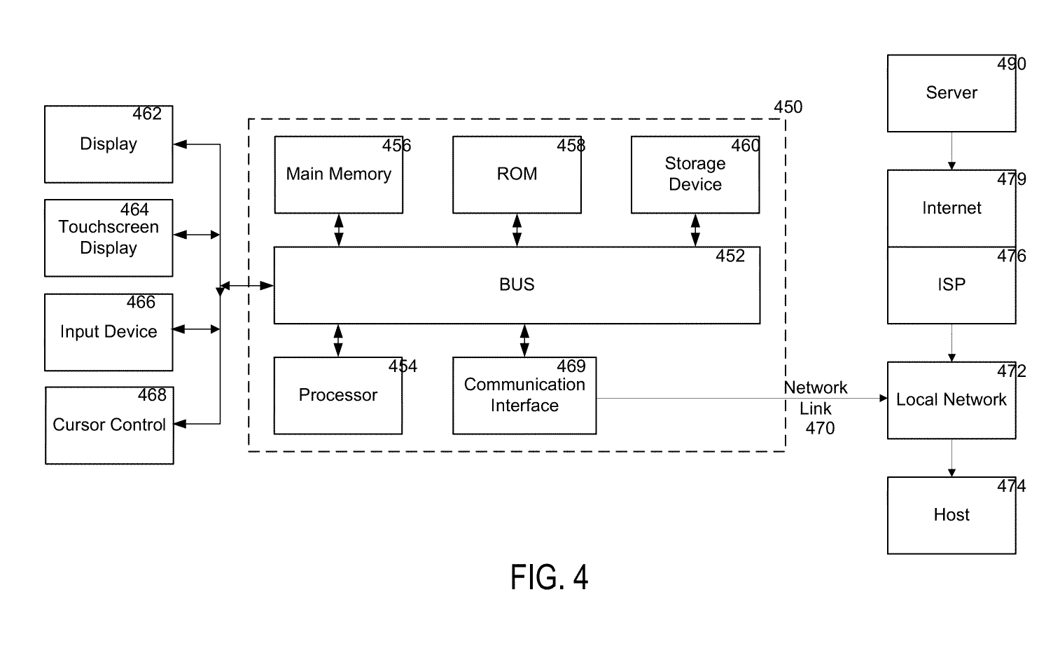

Referring now to FIG. 4, additional aspects of controller hardware useful for implementing the present invention are illustrated as a block diagram that includes a controller 450 upon which an embodiment of the invention may be implemented. Controller 450 includes a bus 452 or other communication mechanism for communicating information, and a processor 454 coupled with bus 452 for processing information.

Controller 450 also includes a main memory 456, such as a random access memory (RAM) or other dynamic storage device, coupled to bus 452 for storing information and instructions to be executed by processor 454. Main memory 456 may also be used for storing temporary variables or other intermediate information during execution of instructions to be executed by processor 454. Controller 450 further includes a read only memory (ROM) 458 or other static storage device 460.

Controller 450 may be coupled via bus 452 to a display 462, such as a cathode ray tube (CRT), liquid crystal display (LCD), plasma display panel (PDP), organic light-emitting diode (OLED), projector, or heads up display for displaying information to a computer user. An input device 466, including alphanumeric and other keys, may be coupled to bus 452 for communicating information and command selections to processor 454. Another type of user input device is cursor control 468, such as a mouse, a trackball, a touchpad, or cursor direction keys for communicating direction information and command selections to processor 454 and for controlling cursor movement on display 462. Another type of user input device is a touchscreen display 464 where a user may communicate information and command selections to processor 454 by tactile interaction with the display thereby controlling cursor movement or alphanumeric and other keys. This input device typically has two degrees of freedom in two axes, a first axis (e.g., x) and a second axis (e.g., y), that allows the device to specify positions in a plane.

Embodiments of the invention are related to the use of controller 450 for setting operational parameters relating to digital messaging and game playing. According to some embodiment of the invention, ParentScreen parameters are defined and managed by controller 450 in response to processor 454 executing one or more sequences of one or more instructions contained in main memory 456. Such instructions may be read into main memory 456 from another computer-readable medium, such as storage device 460. Execution of the sequences of instructions contained in main memory 456 causes processor 454 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 454 for execution. Such a medium may take many forms, including but not limited to, non-volatile media, volatile media, and transmission media. Non-volatile media includes, for example, optical or magnetic disks, such as storage device 460 and 458. Volatile media includes dynamic memory, such as main memory 456. Transmission media includes coaxial cables, copper wire and fiber optics, including the wires that comprise bus 452. Transmission media may also take the form of acoustic or light waves, such as those generated during radio wave and infrared data communications.

Common forms of computer-readable media include, for example, a memory stick, hard disk or any other magnetic medium, a CD-ROM, any other optical medium, a RAM, a PROM, and EEPROM, any other memory chip or cartridge, or any other medium from which a computer may read.

Various forms of computer readable media may be involved in carrying one or more sequences of one or more instructions to processor 454 for execution. For example, the instructions may initially be carried on a magnetic disk of a remote computer. The remote computer can load the instructions into its dynamic memory and send the instructions over a distributed network such as the Internet. A communication device may receive the data on the telephone line, cable line, or fiber-optic line and use an infrared transmitter to convert the data to an infrared signal. An infrared detector can receive the data carried in the infrared signal and appropriate circuitry can place the data on bus 452. Bus 452 carries the data to main memory 456, from which processor 454 retrieves and executes the instructions. The instructions received by main memory 456 may optionally be stored on storage device 460 either before or after execution by processor 454.

Controller 450 also includes a communication interface 469 coupled to bus 452. Communication interface 469 provides a two-way data communication coupling to a network link 470 that may be connected to a local network 472. For example, communication interface 469 may operate according to the internet protocol. As another example, communication interface 469 may be a local area network (LAN) card allowing a data communication connection to a compatible LAN. Wireless links may also be implemented.

Network link 470 typically provides data communication through one or more networks to other data devices. For example, network link 470 provides a connection through local network 472 to a host computer 474 or to data equipment operated by an Internet Service Provider (ISP) 476. ISP 476 in turn provides data communication services through the worldwide packet data communication network now commonly referred to as the “Internet” 479. Local network 472 and Internet 479 both use electrical, electromagnetic or optical signals that carry digital data streams. The signals through the various networks and the signals on the network link 470 and through communication interface 469, which carry the digital data to and from controller 450 are exemplary forms of carrier waves transporting the information.

In some embodiments, Controller 450 may send messages and receive data, including program code, through the network(s), network link 470 and communication interface 469. In the Internet example, a server 490 might transmit a requested code for an application program through Internet 479, ISP 476, local network 472 and communication interface 469.

Processor 454 may execute the received code as it is received, and/or stored in storage device 460, or other non-volatile storage for later execution. In this manner, controller 450 may obtain application code in the form of a carrier wave.

Access devices may include any device capable of interacting with controller or other service provider. Some exemplary devices may include a mobile phone, a smart phone, a tablet, a netbook, a notebook computer, a laptop computer, a wearable computing or electronic device, a terminal, a kiosk or other type of automated apparatus. Additional exemplary devices may include any device with a processor executing programmable commands to accomplish the steps described herein.

A controller may be a programmable board such as an arduino board, and/or one or more of: personal computers, laptops, pad devices, mobile phone devices and workstations located locally or at remote locations, but in communication with the system. System apparatus can include digital electronic circuitry included within computer hardware, firmware, software, or in combinations thereof. Additionally, aspects of the invention can be implemented manually.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors.

Generally, a processor will receive instructions and data from a read-only memory and/or a random access memory. Generally, a computer will include one or more mass storage devices for storing data files; such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EEPROM and flash memory devices; magnetic disks such as, internal hard disks and removable disks; and CD ROM disks. Any of the foregoing can be supplemented by, or incorporated in, ASICs (application-specific integrated circuits).

In some embodiments, implementation of the features of the present invention is accomplished via digital computer utilizing uniquely defined controlling logic, wherein the controller includes an integrated network between and among the various participants in Process Instruments.

The specific hardware configuration used is not particularly critical, as long as the processing power is adequate in terms of memory, information updating, order execution, redemption and issuance. Any number of commercially available database engines may allow for substantial account coverage and expansion. The controlling logic may use a language and compiler consistent with that on a CPU included in the medical device. These selections will be set according to per se well-known conventions in the software community.

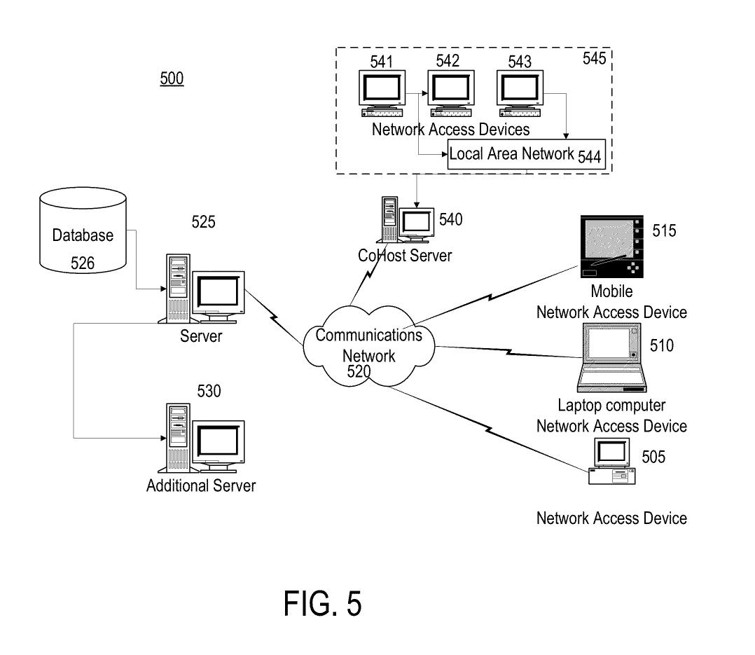

Referring now to FIG. 5, an exemplary processing and interface system 500 is illustrated. In some aspects, access devices 515, 510, 505, such as a mobile device 515 or laptop computer 510 may be able to communicate with an external server 525 though a communications network 520. The external server 525 may be in logical communication with a database 526, which may comprise data related to identification information and associated profile information. In some examples, the server 525 may be in logical communication with an additional server 530, which may comprise supplemental processing capabilities.

In some aspects, the server 525 and access devices 505, 510, 515 may be able to communicate with a cohost server 540 through a communications network 520. The cohost server 540 may be in logical communication with an internal network 545 comprising network access devices 541, 542, 543 and a local area network 544. For example, the cohost server 540 may comprise a payment service, such as PayPal or a social network, such as Facebook or a dating website.

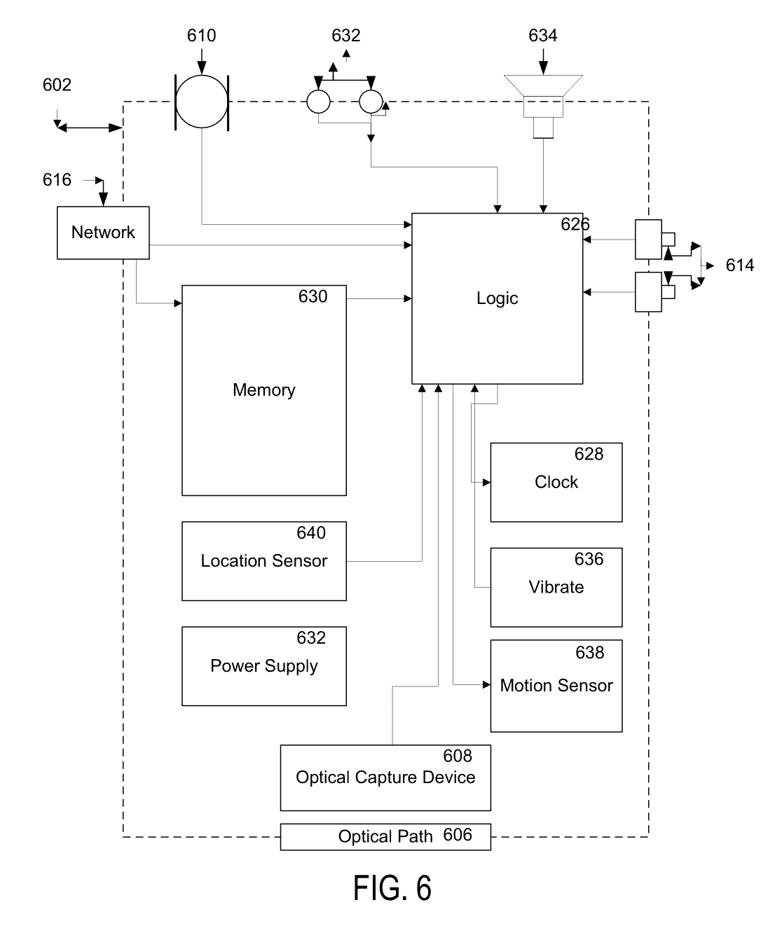

Referring now to FIG. 6, a block diagram of an exemplary embodiment of a mobile device 602 is illustrated. The mobile device 602 may comprise an optical capture device 608, which may capture an image and convert it to machine-compatible data, and an optical path 606, typically a lens, an aperture, or an image conduit to convey the image from the rendered document to the optical capture device 608. The optical capture device 608 may incorporate a Charge-Coupled Device (CCD), a Complementary Metal Oxide Semiconductor (CMOS) imaging device, or an optical sensor of another type.

In some embodiments, the mobile device 602 may comprise a microphone 610, wherein the microphone 610 and associated circuitry may convert the sound of the environment, including spoken words, into machine-compatible signals. Input facilities 614 may exist in the form of buttons, scroll-wheels, or other tactile sensors such as touch-pads. In some embodiments, input facilities 614 may include a touchscreen display. Visual feedback 632 to the user may occur through a visual display, touchscreen display, or indicator lights. Audible feedback 634 may be transmitted through a loudspeaker or other audio transducer. Tactile feedback may be provided through a vibration module 636.

In some aspects, the mobile device 602 may comprise a motion sensor 638, wherein the motion sensor 638 and associated circuity may convert the motion of the mobile device 602 into machine-compatible signals. For example, the motion sensor 638 may comprise an accelerometer, which may be used to sense measurable physical acceleration, orientation, vibration, and other movements. In some embodiments, the motion sensor 638 may comprise a gyroscope or other device to sense different motions.

In some implementations, the mobile device 602 may comprise a location sensor 640, wherein the location sensor 640 and associated circuitry may be used to determine the location of the device. The location sensor 640 may detect Global Position System (GPS) radio signals from satellites or may also use assisted GPS where the mobile device may use a cellular network to decrease the time necessary to determine location. In some embodiments, the location sensor 640 may use radio waves to determine the distance from known radio sources such as cellular towers to determine the location of the mobile device 602. In some embodiments these radio signals may be used in addition to and/or in conjunction with GPS.

In some aspects, the mobile device 602 may comprise a logic module 626, which may place the components of the mobile device 602 into electrical and logical communication. The electrical and logical communication may allow the components to interact. Accordingly, in some embodiments, the received signals from the components may be processed into different formats and/or interpretations to allow for the logical communication. The logic module 626 may be operable to read and write data and program instructions stored in associated storage 630, such as RAM, ROM, flash, or other suitable memory. In some aspects, the logic module 626 may read a time signal from the clock unit 628. In some embodiments, the mobile device 602 may comprise an on-board power supply 632. In some embodiments, the mobile device 602 may be powered from a tethered connection to another device, such as a Universal Serial Bus (USB) connection.

In some implementations, the mobile device 602 may comprise a network interface 616, which may allow the mobile device 602 to communicate and/or receive data to a network and/or an associated computing device. The network interface 616 may provide two-way data communication. For example, the network interface 616 may operate according to an internet protocol. As another example, the network interface 616 may comprise a local area network (LAN) card, which may allow a data communication connection to a compatible LAN. As another example, the network interface 616 may comprise a cellular antenna and associated circuitry, which may allow the mobile device to communicate over standard wireless data communication networks. In some implementations, the network interface 616 may comprise a Universal Serial Bus (USB) to supply power or transmit data. In some embodiments, other wireless links known to those skilled in the art may also be implemented.

As an illustrative example of a mobile device 602, a reader may scan some text from a newspaper article with mobile device 602. The text is scanned as a bit-mapped image via the optical capture device 608. Logic 626 causes the bit-mapped image to be stored in memory 630 with an associated time-stamp read from the clock unit 628. Logic 626 may also perform optical character recognition (OCR) or other post-scan processing on the bit-mapped image to convert it to text. Logic 626 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 626) to an associated computer via network interface 616.

As an example of another use of mobile device 602, a reader may capture some text from an article as an audio file by using microphone 610 as an acoustic capture port. Logic 626 causes audio file to be stored in memory 628. Logic 626 may also perform voice recognition or other post-scan processing on the audio file to convert it to text. As above, the reader may then upload the audio file (or text produced by post-scan processing performed by logic 626) to an associated computer via network interface 616.

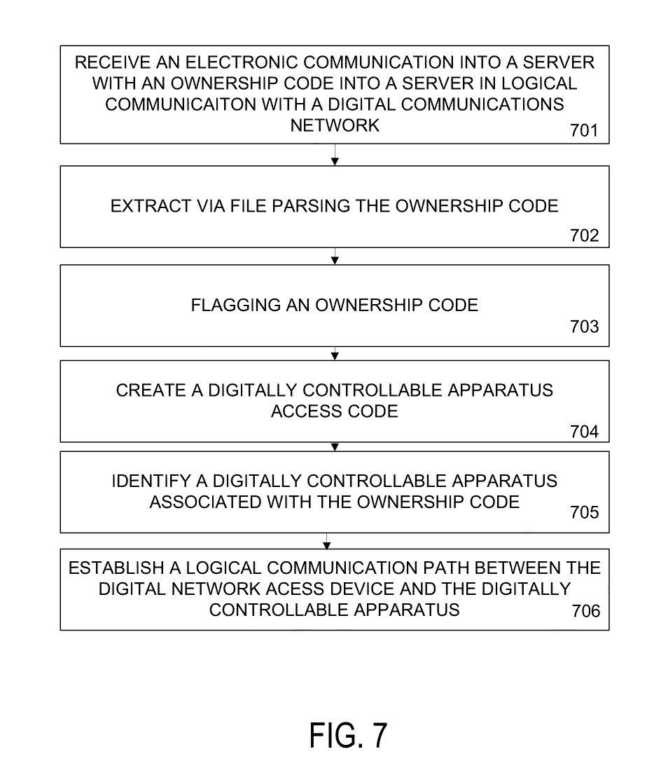

Referring now to FIG. 7, a flow diagram illustrates some exemplary steps that may be executed in some implementations of the present invention. At 701, an electronic communication with an ownership code is received into a server in logical with a digital communications network. At 702, the ownership is extracted via file parsing. At 703 an ownership code byte is flagged between a beginning marker and a successive end ownership code marker and continuing scanning until no further beginning ownership code marker is found. At 704 a new digitally controllable apparatus access command is created by sequentially copying all ownership code data bytes into an apparatus access file. At 705 a digitally controllable apparatus associated with the ownership code is identified; and at 706 a logical communication path is established between the digital network access device and the digitally controllable apparatus.

### CONCLUSION

A number of embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. An apparatus for storing information owned by multiple disparate owners, the apparatus comprising:
an automated support infrastructure providing power and logical communication to a communications network;
a digital storage physically secured in the support structure and in logical communication with the communications network via the support structure;
a processor in logical communication with the support structure for controlling digital communication with devices inserted into the support structure; and
executable software stored on a memory in communication with the processor and executable on demand, the software operative with the processor to cause the apparatus to:
allocate an ownership interest in one or more storage devices to a legal entity;
receive digital data;
store the digital data on the one or more storage devices for which an ownership interest has been allocated to the legal entity; and
transmit digital data from the more storage devices for which an ownership interest has been allocated over the communications network.

2. A computer-implemented method for providing remote access to a digitally controllable apparatus via an electronic communication, the method comprising executing on a processor the steps of:
receiving an electronic communication into a Digital Common Area server from a digital communication network access device, said electronic communication containing an ownership code of a digitally controllable apparatus;
extracting, via file parsing, the ownership code from the electronic communication to create an ownership designation of the digitally controllable apparatus, wherein the extracting comprises scanning the communication for an identified beginning ownership code marker;
flagging an ownership code byte between the beginning marker and a successive end ownership code marker, continuing scanning until no further beginning ownership code marker is found;
creating a new digitally controllable apparatus access command by sequentially copying all ownership code data bytes into an apparatus access file;
identifying a digitally controllable apparatus associated with the ownership code; and
establishing a logical communication path between the digital network access device and the digitally controllable apparatus.
